(19) United States
(12) Patent Application Publication
(10) Pub. No.: US 2014/0251072 A1
(43) Pub. Date: Sep. 11, 2014

(54) SKATEBOARD/SNOWBOARD SPINNING KNOB HANDLE

(71) Applicants: Gerard J. LaBrie, Cypress, CA (US); Sean A. Mallard, Westminster, CA (US)

(72) Inventors: Gerard J. LaBrie, Cypress, CA (US); Sean A. Mallard, Westminster, CA (US)

(21) Appl. No.: 13/786,578

(22) Filed: Mar. 6, 2013

(51) Int. Cl. B62B 5/06

(52) U.S. Cl. CPC B62B 5/06
USPC 74/551.4; 74/551.9

(57) ABSTRACT

A spinning knob adaptable to a handle of a skateboard or a snowboard (hereinafter referred to as “board”), wherein the handle is fixedly connected to an abutment on any portion of the upper surface of board. Handle is fixedly attached to upper surface such that it is stationary during the operation of board. A bearing is disposed between knob and handle such that only the spinning knob rotates relative to the board. Rotation of the spinning knob can be bi-directional (CCW and CW) or only a single direction (CCW or CW). The handle can be a single, mono-structure with a fixed length or a telescoping configuration with multiple components in slideable engagement capable of being locked to form variable lengths or heights. Several embodiments of the board are possible by affixing one or more handles (telescoping or mono-structure) to the board at the front end, center portion, and/or aft end.

### FIELD OF THE INVENTION

The present invention is related generally to the field of skateboard/snowboard equipment, in particular to a spinning knob adapted to a handle that provides the capability to perform stunts and trick maneuvers, and to reduce or eliminate wrist injuries caused by disembarking the skateboard/snowboard.

### BACKGROUND OF THE INVENTION

Current skateboard handle knobs are fixedly attached to the end of a stationary longitudinal handle that is fixedly attached to the skateboard truck or deck. This configuration is known to cause wrist injuries and inhibits the boarder's ability to perform stunts and trick maneuvers.

### SUMMARY OF THE INVENTION

The present invention is a spinning knob adaptable to a handle of a skateboard or a snowboard (hereinafter referred to as “board”), wherein the handle is fixedly connected to an abutment on any portion of the upper surface of the board. The handle is fixedly attached to the upper surface such that it is stationary during the operation of the board. A bearing housing is disposed between the knob and the handle such that only the spinning knob rotates relative to the handle and the board. The rotation of the spinning knob can be bi-directional (CCW—counterclockwise and CW—clockwise) or only a single direction (CCW—counterclockwise or CW—clockwise). The handle can be a single, mono-structure with a fixed length or a telescoping configuration with multiple components in slideable engagement capable of being locked together to form variable lengths or heights. Several embodiments of the board are possible by affixing one or more handles (telescoping or mono-structure) to the board, for example, at the front end, center section, and/or aft end.

For a better understanding of the present invention, reference is made to the accompanying drawings and detailed description.

### BRIEF DESCRIPTION OF THE DRAWINGS

The present invention is illustratively shown and described in reference to the accompanying drawings, in which:

FIG. 1 is a bottom view of the exemplary embodiment of the present invention illustrating the bearing assembly;

FIG. 2 is a perspective view of an exemplary embodiment of the present invention adapted to a telescoping handle fixedly connected to a front end on the upper surface of a skateboard;

FIG. 3 is a perspective view of an exemplary embodiment of the present invention adapted to a front end on the upper surface of a snowboard;

FIG. 4 is a perspective view of another embodiment of a skateboard with two handles adapted with the spinning knob; and

FIG. 5 is a perspective view of another embodiment of the spinning knob adapted to a mono-structure handle fixedly connected to a front end on the upper surface of a skateboard.

### DETAILED DESCRIPTION OF THE INVENTION

As used herein in the specification and claims, including as used in the examples and unless otherwise expressly specified, all numbers may be read as if prefaced by the word “about”, even if the term does not expressly appear. Also, any numerical range recited herein is intended to include all sub-ranges subsumed therein.

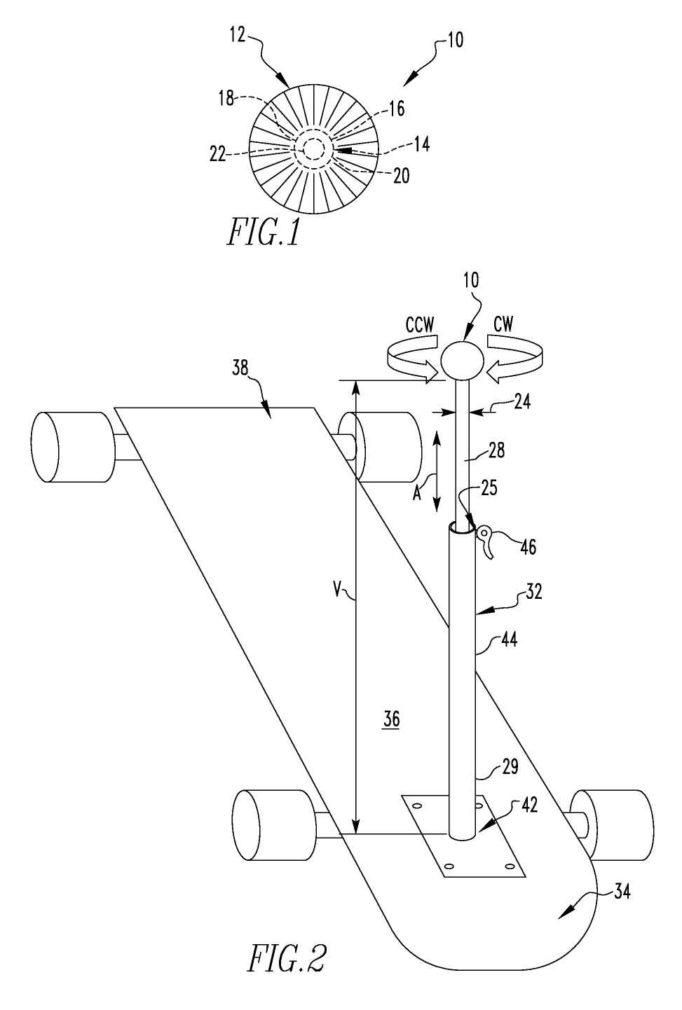

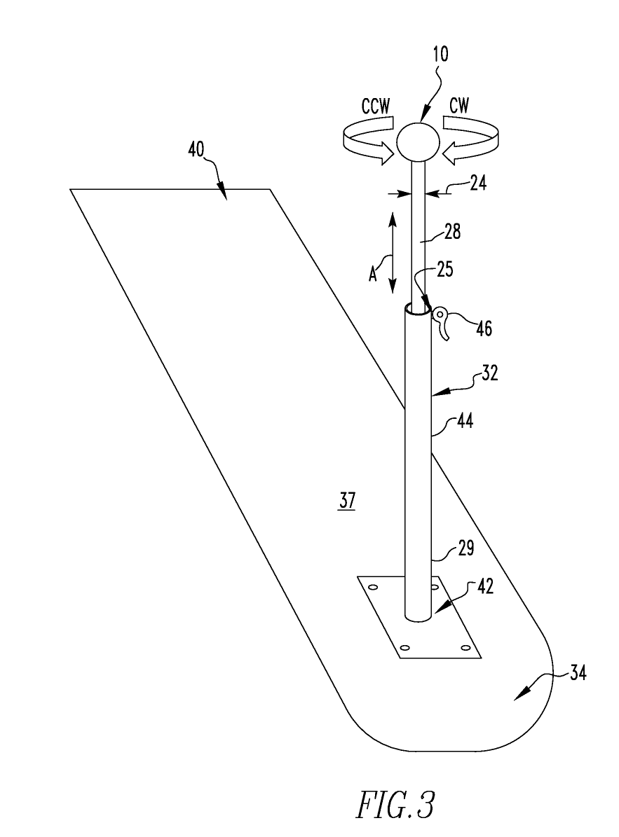

Now turning to FIG. 1 that illustrates a bottom view of an exemplary embodiment of the spinning knob 10 having a hand grip 12 molded to conform to a palm of an hand and a bearing housing 14 fixedly connected to hand grip 12. Bearing housing 14 having a set of bearings therein can be connected to hand grip 12 by any conventional means such as, but not limited to, an interference fit (outer diameter 16 of bearing housing 14 is greater than inner diameter 18 of center hole 20 of hand grip 12), fasteners (screws, bolts, rivets), and adhesives. The inner diameter 22 of bearing housing 14 can be adapted fit any outer diameter 24, 26 of a distal end 28, 30 of handle 32, 33 (see FIGS. 2-5).

Now turning to FIGS. 1-3 illustrating telescoping handle 32 having a proximal end 29, 31 fixedly connected to a front end 34 on the upper surface 36, 37 of skateboard 38 and snowboard 40. The spinning knob 10 can be adaptable to any handle 32 of a skateboard 38 or a snowboard 40 (hereinafter referred to as “board”). Handle 32, 33 is fixedly connected to an abutment 42, 43 on any portion of the upper surface 36, 37 of board 38, 40. Handle 32, 33 is fixedly attached to upper surface 36, 37 such that it is stationary during the operation of board 38, 40. Bearing housing 14 is disposed on receiving end 24, 26 of handle 32, 33 such that only spinning knob 10 bi-directionally rotates (CCW—counterclockwise and CW—clockwise) relative to board 38, 40. Alternative embodiments of spinning knob 10 can be limited to a single rotational direction either CCW—counterclockwise or CW—clockwise.

As mentioned above, handle 32 can be a telescoping configuration with multiple components (inner component 28, outer component 44) in slideable engagement capable of being locked together at a predetermined location by conventional lock 46 to form variable lengths or heights V. Outer diameter 24 of the inner component 28 slideably engages an inner diameter 25 of the outer component 44. Handle 32 can telescope in Direction A.

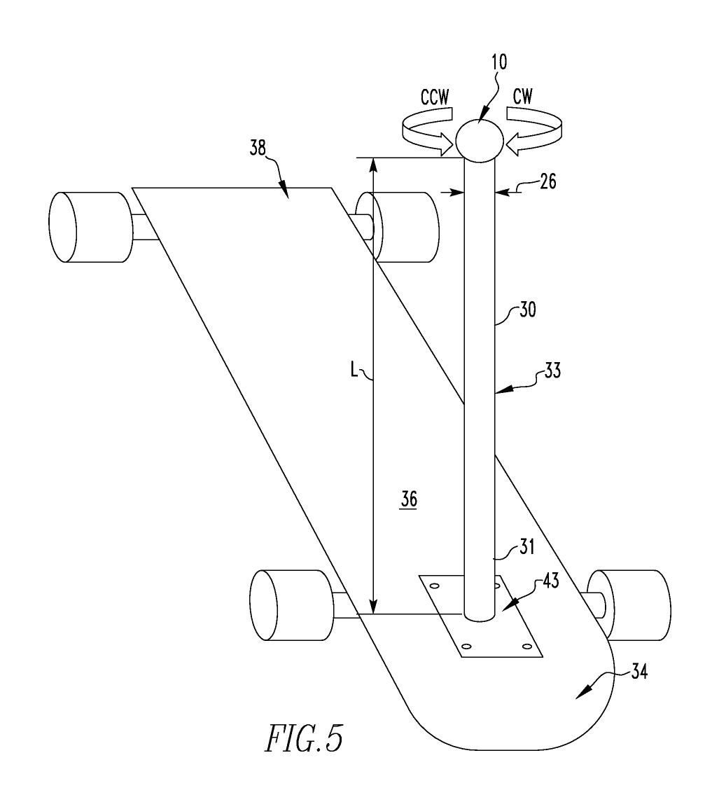

Now turning to FIG. 5 illustrating alternative handle 33 made of a single, mono-structure with a fixed length L.

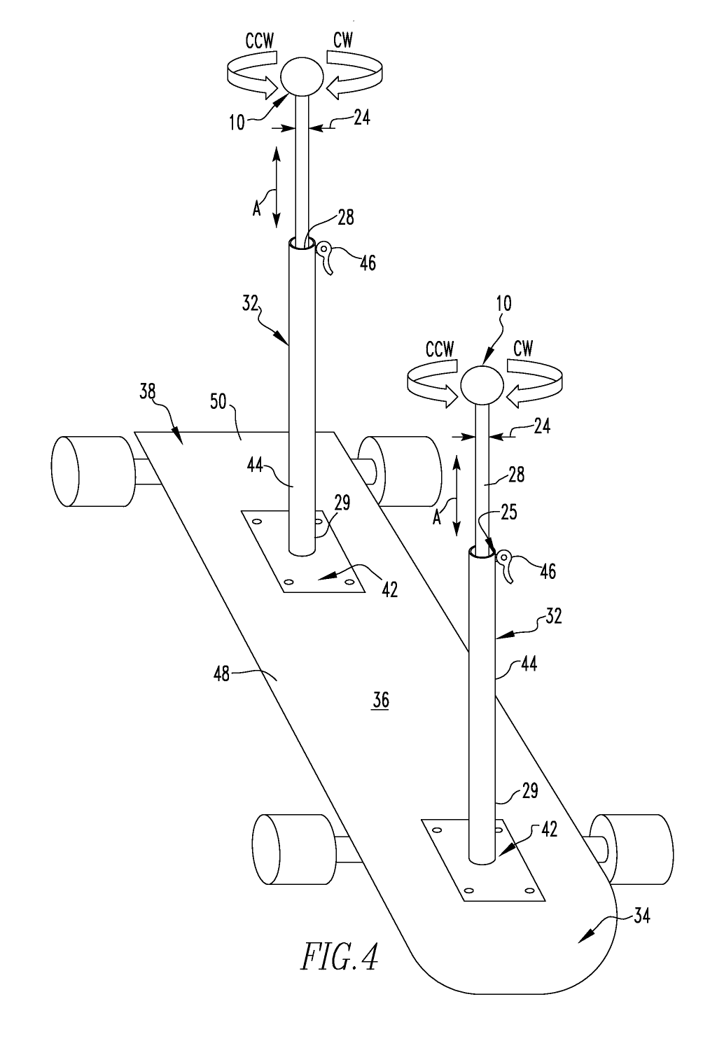

Now turning to FIG. 4 illustrating another embodiment of a skateboard 38 adapted with two handles 32 including the present invention 10. Two, three, or more handles 32 can be fixedly attached to either a skateboard 38 or a snowboard 40 at, for example, the front end 34, center portion 48, and aft end 50. Handles can be either telescopic handles 32 or mono-structure handles 33.

Although the present invention has generally been described in terms of specific embodiments and implementations, the present invention is applicable to other methods, apparatuses, systems, and technologies. The examples provided herein are illustrative and not limiting, and other variations and modifications of the present invention are contemplated. Those and other variations and modifications of the present invention are possible and contemplated, and it is intended that the foregoing specification and the following claims cover such modifications and variations.

1. A spinning knob capable of being adapted to a handle of a skateboard or a snowboard comprising,
a hand grip having a center hole with an inner diameter and an outer surface contoured to conform to a palm of a hand; and
a bearing housing having a set of bearing connected to the hand grip,
wherein the hand grip rotates relative to the handle.

2. The spinning knob according to claim 1, wherein the bearing housing having a set of bearing, wherein the bearing housing has an outer diameter greater than the inner diameter of the center hole of the hand grip to cause an interference fit between the hand grip and the bearing housing to retain the bearing housing within the hand grip, wherein the bearing housing has an inner outer sized to receive the handle of the skateboard or the snowboard.

3. The spinning knob according to claim 1, wherein the hand grip rotates in a counterclockwise direction relative to the handle.

4. The spinning knob according to claim 1, wherein the hand grip rotates in a clockwise direction relative to the handle.

5. The spinning knob according to claim 1, wherein the hand grip rotates in a counterclockwise direction and a clockwise direction relative to the handle.

6. A handle for a skateboard or a snowboard comprising,
a longitudinal handle having a distal end and a proximal end, wherein the proximal end is capable of being fixedly attached to a truck of the skateboard or the snowboard; and
a knob attached to the distal end of the longitudinal handle, wherein the knob rotates relative to the handle.

7. The handle according to claim 6, wherein the knob rotates in a counterclockwise direction relative to the longitudinal handle.

8. The handle according to claim 6, wherein the knob rotates in a clockwise direction relative to the longitudinal handle.

9. The handle according to claim 6, wherein the knob rotates in a counterclockwise direction and a clockwise direction relative to the longitudinal handle.

10. The handle according to claim 6, wherein the longitudinal handle further comprises a mono-structure having a predetermined length.

11. The handle according to claim 6, wherein the longitudinal handle further comprises a telescoping configuration with an inner component and an outer component, wherein an outer diameter of the inner component slideably engages an inner diameter of the outer component, wherein the inner component and outer component are capable of being locked together to form variable lengths or heights.

12. A skateboard or a snowboard comprising,
a truck having a front end, a center section, and an aft end;
a longitudinal handle having a distal end and a proximal end, wherein the proximal end is fixedly attached to either the front end, the center section, or the aft end of the truck; and
a knob attached to the distal end of the longitudinal handle, wherein the knob rotates relative to the handle.

13. The skateboard or a snowboard according to claim 12, wherein the knob rotates in a counterclockwise direction relative to the longitudinal handle.

14. The skateboard or a snowboard according to claim 12, wherein the knob rotates in a clockwise direction relative to the longitudinal handle.

15. The skateboard or a snowboard according to claim 12, wherein the knob rotates in a counterclockwise direction and a clockwise direction relative to the longitudinal handle.

16. The skateboard or a snowboard according to claim 12, wherein the longitudinal handle further comprises a mono-structure having a predetermined length.

17. The skateboard or a snowboard according to claim 12, wherein the longitudinal handle further comprises a telescoping configuration with an inner component and an outer component, wherein an outer diameter of the inner component slideably engages an inner diameter of the outer component, wherein the inner component and outer component are capable of being locked together to form variable lengths or heights.

18. The skateboard or a snowboard according to claim 12, further comprising two longitudinal handles fixedly attached to the truck.

19. The skateboard or a snowboard according to claim 12, further comprising three longitudinal handles fixedly attached to the truck.
